(19) United States
(12) Patent Application Publication
(10) Pub. No.: US 2006/0174606 A1
(43) Pub. Date: Aug. 10, 2006

(54) High static thrust valveless pulse-jet engine with forward-facing intake duct

(76) Inventor: Michael A. Stram, Chicago, IL (US)

Correspondence Address: MICHAEL A. STRAM, 5442 SO. NASHVILLE AVE., CHICAGO, IL, 60638, US

(21) Appl. No.: 11/301,940

(22) Filed: Dec. 14, 2005

Related U.S. Application Data
(60) Provisional application No. 60/651,435, filed on Feb. 10, 2005.

(51) Int. Cl. F02K 7/02

(52) U.S. Cl. 60/247

(57) ABSTRACT

A self-starting, self-aspirating valveless pulse-jet engine maximized to capture air during static operation. This invention is an improved adaptation of my U.S. Pat. No. 6,216,446, and continues to utilize a combustor tube, a forward-facing intake duct, a flame holder, a fuel supply means, and a spark plug to ignite the fuel-air mixture. To improve static air capture, the intake tubes of the intake duct, forward of the primary intake tube, that is joined to the combustion chamber, feature aggressively enlarged forward inlet mouths. By adjusting the relative diameters of the intake tubes that are inserted into each other, to achieve a greater difference of diameters, this adjustment, combined with aggressively enlarged intake tube mouths dramatically increases the ability of the intake duct to capture a maximum of air during static operation. Tests have shown the enlarged mouths are equally effective either as enlarged cupped mouths or as enlarged cones. Further improvement in air capture has been gained by adjusting the position of the aft end of the intake tube that is inserted inside the primary intake tube, so its position is in a range that is even with the plane created by the combustion chamber forward wall or just outside of the combustion chamber and closer to the mouth of the primary intake tube. (According to my U.S. Pat. No. 6,216,446, this intake tube was located so its aft end was inside the combustion chamber.) Further improvement in static air capture is made by specifying a diameter of the exhaust tube tail that has proved superior for air capture during static research testing. Capture of more air during static operation increases burn rate and thrust, and lowers specific fuel consumption, due to burning of leaner air-fuel mixtures. This invention also has improved thrust during dynamic operation, because the enlarged intake tube mouths capture more air during forward movement of the engine.

### CROSS REFERENCE TO RELATED PATENT

This application claims the benefits of my U.S. Provisional Patent Application Ser. No. 60/651,435, filed Feb. 10, 2005, and is directly related to my U.S. Pat. No. 6,216,446. Many of the construction features and the mode of operation are identical to the above referred U.S. Pat. No. 6,216,446.

### BACKGROUND OF THE INVENTION

1. Field of the Invention

This invention relates to tubular jet engines and pulse-jets of the valveless type that are self-starting, self-aspirating, and consist of a tubular combustor tube and a forward-facing intake duct. These engines have no moving parts and operate on gaseous volatile hydrocarbons, such as propane and ethane, or vaporized liquid fuels, such as gasoline or kerosene. Usually, these engines have an intake duct consisting of a multiplicity of intake tubes inserted into each other. Some self-starting ram jets belong to this field of invention.

2. Description of the Prior Art

The closest related prior art is my U.S. Pat. 6,216,446, issued Apr. 17, 2001. Other engines possess most of the features mentioned above but not all; therefore, they are only indirectly related to this invention. As an example, of the pulse-jet engine types, the Gluhareff engine, specified in U.S. Pat. No. 3,093,962 has an intake duct consisting of several intake tubes, but the duct is positioned at a 90 degree angle to the axis of the combustor tube. A forward-facing intake duct is an essential feature of this invention, to allow capture of ram air during forward motion. Another pulse-jet engine device, described in U.S. Pat. No. 3,035,413, titled “Thermodynamic Combustion Device Using Pulsating Gas Pressure,” has a forward-facing intake duct, consisting of three intake tubes, but the engine requires compressed air to start; it is not self-starting. Some self-starting ram jets possess most features of the relevant prior art, but not all; again, they are only indirectly related to this invention. Here are some examples: U.S. Pat. No. 3,514,956, issued to W. R. Bray in 1970, titled “Injector-Ram Jet Engine,” describes an engine that has a forward-facing intake duct consisting of several intakes tubes, but the engine operates on a continuous supply of compressed air for static operation; it is not self-aspirating, U.S. Pat. No. 2,663,142, issued to W. H. Wilson in 1953, titled “Thermojet Engine,” covers engines featuring a forward-facing intake duct consisting of several intake inlets of increasing diameters, but upon close inspection, the engine employs propane and oxygen only as a pilot fuel, to induce a reaction of its main fuel, a solution of methanol and water. In U.S. Pat. No. 3,768,257, titled, “Momentum Compression Ramjet,” the inventor describes an engine that has a single forward-facing intake duct, and operates on ethane. Because it employs only one aspiration stage, the single intake tube, by itself can not aspirate sufficient air to achieve a high burn rate during static operation and produce acceptable static thrust. This author believes engines covered in U.S. Pat. No. 3,768,257 also experience severe burning in the intake, causing reduced static thrust, as less-fuel reaches the combustion chamber-and is available for combustion. In conclusion, I refer to my U.S. Pat. No. 6,216,446 as the closest related prior art.

### SUMMARY OF THE INVENTION

Starting with a preferred embodiment of my engine covered in U.S. Pat. No. 6,216,446, my objective was to find novel modifications to improve performance, specifically, to maximize static thrust, improve dynamic thrust, and, if possible, lower fuel consumption under both conditions. This meant discovering novel modifications that would increase the ability of the engine to capture more air, since more air would enable more fuel to be burned in a given moment, resulting in higher throttling, greater static thrust, and a lowering of specific fuel consumption, due to burning of leaner air-fuel mixtures. The primary focus of continued testing was to increase static thrust, by studying and testing modifications to the intake duct. Because the engine is a pulse-jet, and it captures air from the exhaust tail, it was also necessary to find the diameter of the exhaust tail that would lead to maximum static thrust, and also determine if engine length could be modified in any way to improve static thrust. This invention incorporates all the modifications that were found to accomplish the stated objectives, those being: inclusion of aggressively enlarged intake tube mouths of the intake duct, combined with adjusting the relative intake tube diameters of those tubes inserted into each other; adjusting the position of the intake tube that is inserted inside the primary intake tube that is joined to the forward combustion chamber wall, and finding the most effective diameter for the exhaust tail tube to capture air during static operation

### BRIEF DESCRIPTION OF THE DRAWINGS

The invention, both as to its organization and method of operation, together with its advantages, will be more fully understood by reference to the following detailed description and attached drawings accompanying the same.

FIG. 1 is a longitudinal sectional view, showing an embodiment of the present invention, showing the complete jet engine.

FIG. 2 is a fragmentary longitudinal sectional view, showing a modified form of the engine in FIG. 1, illustrating another form of an enlarged intake tube mouth, affixed to the first two forward intakes tubes, as covered by this invention.

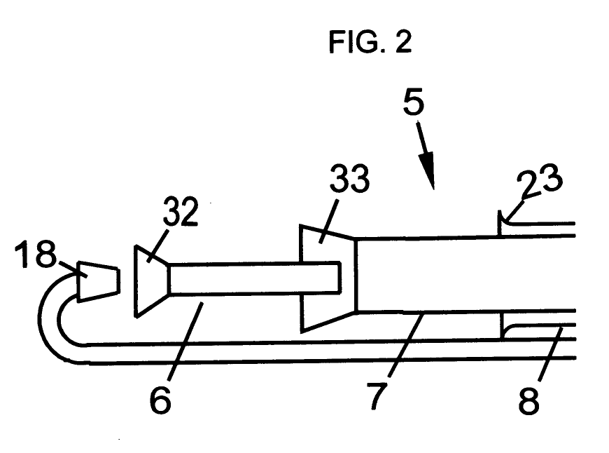

### DESCRIPTION OF THE PREFFERED EMBODIMENT

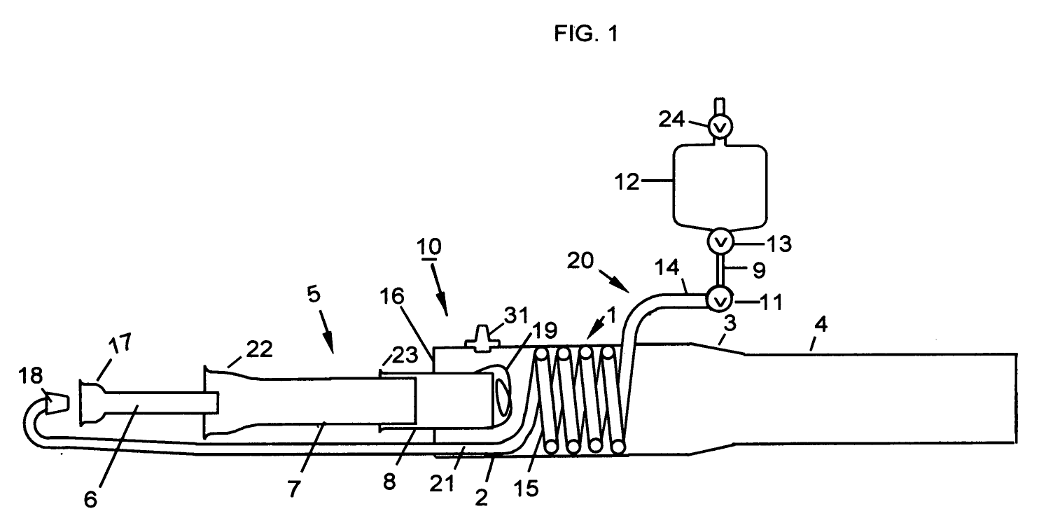

Referring now to FIG. 1, there is illustrated a valveless, self-starting, self-aspirating pulse-jet engine 10, which is comprised of a cylindrical combustor tube 1, an intake duct 5, a fuel supply means 20, and a flame holder 19. The combustor tube 1 has a length of 5.5 times the diameter of the combustion chamber 2. Engines of this invention operate successfully when the combustor tube 1 has a length of 4-9 times the diameter of the combustion chamber 2, but for best operation, the combustor tube 1 length should fall in a range of 5-7 times the diameter of the combustion chamber 2. I have found that engine length is not a critical dimension; when adjusted to the preferred length, engines of this invention may operate better but may not necessarily develop more static or dynamic thrust. The combustor tube 1 consists of a cylindrical combustion chamber 2, having a flat forward face 16, communicating with a reducing cone 3, which is connected to an exhaust tail tube 4. Engines of this invention may also have a combustion chamber 2 with a convex forward face. The dimensional length of the combustion chamber 2, relative to the overall length of engine 10, is not critical for successful operation of engine 10, or for maximizing thrust. Extensive experiments have shown that the exhaust tail tube 4 can be successfully replaced by extending the length of the reducing cone 3 to where the exhaust tail tube 4 normally ends, as long it ends in the same diameter as the exhaust tail tube 4. The diameter of the exhaust tail tube 4 or the end diameter of engine is 0.80 times the diameter of the combustion chamber 2. It is important to understand a pulse-jet engine, in addition to capturing air through its intake, also captures air by pulling in air through its exhaust tail tube during the negative or vacuum cycle. Engines of this invention will operate successfully when the diameter of exhaust tail tube 4 is 0.66-0.90 times the diameter of the combustion chamber 2, but maximum static thrust occurs when the exhaust tail tube 4 diameter is 0.75-0.085 times the diameter of the combustion chamber 2. The combustor tube 1 is equipped with an intake duct 5, which consists of three intake tubes: intake tubes 6, 7, and 8. The forward ends of intake tubes 6 and 7 feature aggressively enlarged cupped mouths 17 and 22, both mouths ending in forward flares. Cupped mouth 17 on intake tube 6 is approximately 100% larger in diameter than the aft end diameter of intake tube 6, and cupped mouth 22 on intake tube 7 is approximately 40% larger in diameter than the aft end diameter of intake tube 7. Aggressively enlarged forward inlet mouths on intake tubes 6 and 7 may fall into a range of 40-100% larger in diameter than their aft end tube diameters. The enlarged mouth on intake tube 6 should be larger relative to its aft end diameter than the enlarged mouth diameter on intake tube 7, relative to its aft end diameter. Intake tube 8 only has a flared forward mouth, slightly larger than tube 8's diameter. Installing an aggressively enlarged forward mouth on tube 8 does not increase static thrust, but does increase dynamic thrust, when the engine is moving through the air. Though not shown, an aggressively enlarged forward mouth is recommended on intake tube 8, to increase dynamic thrust. This modification falls within the scope of this invention. Employing aggressively enlarged forward intake tube mouths on all the intake tubes of the intake duct 5 assures dramatic increases in both static and dynamic thrust. The first stage intake tube 6, at the forward end of the intake duct 5, is inserted partially into the forward end of the 2^{nd} stage intake tube 7. Intake tube 6 has an aft end diameter of 40% of the diameter of the aft end of intake tube 7. Intake tube 6 may have an aft end diameter of 35-55% of the diameter of the aft end of intake tube 7. The combination of aggressively enlarged intake tube mouths 17 and 22, and the adjustment of the relative intake tube diameters of intake tube 6 and 7, where intake tube 6 is inserted into intake tube 7, adds to increases of both static and dynamic thrust created by enlarged intake tubes intake mouths 17 and 22. The effect of both modifications replaces any need to add an additional intake tube in the intake duct, to provide an additional air capture stage. Additional intake tubes may, however, have positive results for very large engines. Intake tube 7 is inserted into the 3^{rd} stage intake tube 8. Intake tube 7 is positioned so that its aft end is at a distance which is ½ of its aft end diameter from the vertical plane created by the forward wall 16 of combustion chamber 2. Intake duct 5 will perform successfully and block all combustion gases from backing out the combustion chamber 2 through the intake duct 5, when the aft end of the intake tube 7 is positioned at a point which is 0-1.0 times its diameter from the vertical plane created by the forward wall 16 of the combustion chamber 2. In my aforementioned U.S. Pat. No. 6,216,446, intake tube 7 was positioned inside the combustion chamber 2, but by placing it at the vertical plane of combustion wall 16 or just outside combustion chamber 2, and closer to the mouth 23 of intake tube 8, intake tube 7 is able to aspirate more air into combustion chamber 2, through mouth 23. The change in position of intake tube 7 increases static thrust, and maintains the ability of the intake duct 5 to act as a valve, blocking all combustion gases during the positive pressure cycle. Intake tube 7 has an aft end diameter that is 87% of the aft end diameter of intake tube 8. Intake tube 7 may have an aft end diameter of 80-95% of the aft end diameter of intake tube 8. Intake tube 8, designated as the primary intake tube, has a length equal to the diameter of the combustion chamber 2, and a diameter (except for its flared forward mouth) of 50% of combustion chamber 2. I have found that static thrust increases with the diameter of intake tube 8, however when its diameter exceeds 55% of the diameter of the combustion chamber 2, the intake duct 5 fails to block all combustion gases during the positive or pressure combustion cycle; that is, the intake duct 5 will begin to fail as a valve. The diameter of intake tube 8 should fall in a range of 40-50% of the diameter of combustion chamber 2. Intake tube 8 extends into the combustion chamber 2, to a length approximately equal to ½ of its length; intake tube 8 passes through the center of the forward face 16 of the combustion chamber 2, and is joined around its circumference to the combustion chamber 2. Intake tube 6 passes through the center of intake tube 7, and intake tube 7 passes through the center of intake tube 8. The diametrical centers of intake tubes 6, 7, and 8 are in alignment, and this is a requirement for successful operation of engine 10. Intake tube 6 has a length of 0.66 times the length of intake tube 7. Experimentally, I have found that the length of intake tube 6 may range from 0.5-1.0 times the length of intake tube 7. Intake tube 7 has a length of 1.8 times the length of intake tube 8, but it may fall in a range of 1.25-2.0 times the length of intake tube 8.

The embodiment engine 10 illustrated in FIG. 1 is configured to operate on liquefied gaseous fuels such as propane or butane. It is possible to configure the engine to operate on other fuel combinations as described hereinafter. The fuel supply means 20 is identical to the fuel supply means 20 of my engine described in my aforementioned U.S. Pat. No. 6,216,446, and it is comprised of a fuel tank 12, a conventional fuel valve 24, a fuel supply valve 13, leading to a fuel feed line 9, which draws liquid fuel from the bottom of fuel tank 12, and is interrupted by a suitable throttle valve 11. The opposite side of the throttle valve 11 feeds into a vaporizer tube 14 that is larger in diameter than the fuel feed line 9. The vaporizer tube 14 penetrates into the interior of engine 10 through a small hole in the combustion chamber 2, and then is coiled in combustion chamber 2, to provide a series of superheated vaporizer coils 15. Coiling of the vaporizer tube 14 ends in a straight section 2 which extends to the outside atmosphere through a small hole in the front forward face 16 of the combustion chamber 2, and then continues to a point where it is turned back 180 degrees to face the enlarged intake mouth 17 of intake tube 6. It is not critical for vaporizer coil 15 to exit the combustion chamber 2 through the forward wall 16; it may also exit the combustion chamber 2 through the horizontal wall of combustion chamber 2, and then turn at 90 degrees forward in a straight section towards intake tube 6, and then turn back 180 degrees to face intake mouth 17. The end of the vaporizer tube 14 is fitted with a supersonic fuel nozzle 18 common to the art, and said fuel nozzle 18 is positioned in front and to the center of the enlarged intake mouth 17 of intake tube 6. The flame holder 19 is of the same form and function, as the flame holder 19 described in my U.S. Pat. No. 6,216,446. The spark plug 31 has the same function and its location requirement is the same as in my U.S. Pat. No. 6,216,446. I have found that two kinds of aggressively enlarged intake tube mouths are equally effective in capturing air during static and dynamic operation: Enlarged intake mouths 17 and 22 represent one successful type. Another second type of enlarged intake mouth, 32 and 33, as illustrated in FIG; 2 consisting of a simple cone affixed to the forward ends of intake tubes 6 and 7, is equally effective, as long as its largest diameter is the same as the diameter at the flared ends of intake mouths 17 and 22. Intake tube 8 may also have an aggressively enlarged conical mouth, to increase dynamic thrust.

Engines of this invention are primarily constructed from stainless steel although, other higher temperature metals, such as titanium are suitable. Engine 10 in FIG. 1 was principally constructed from stainless steel.

Operation of the Engine

Operation of engine 10 is identical to my engine described in my U.S. Pat. No. 6,216,446. Briefly, in placing engine 10 into operation, the fuel supply valve 13 is opened, allowing fuel such as propane or butane to flow to fuel throttle valve 11; said throttle valve 11 is opened slightly, causing liquid fuel to flow to the vaporizer tube 14, and then through the vaporizer coils 15, and then to the fuel nozzle 18, where it exits as a vapor under atmospheric pressure, and then is directed into intake duct 5, and then into the combustion chamber 2. Activating spark plug 31, causes the mixture to ignite. The engine starts, and the throttle valve 11 is opened more allowing more fuel to flow through the vaporizer coils 15, where it is vaporized by heat of combustion. Once the engine starts, the spark plug 31 may be turned off and operation is stable. As the throttle valve 11 is opened more, engine 10 begins to build more thrust. When shut down is desired, throttle valve 11 is closed.

Engines of this invention may also be operated on highly volatile hydrocarbons such as gasoline and kerosene, either as vapors or as liquid mists. Operating on liquid mists requires the engines to be moving forward at high speed, receiving ram air through the intake duct for combustion. Operating on gasoline or kerosene as vapors requires two separate and complete fuel supply means of the same type as fuel supply means 20 on engine 10. When operating on liquid gasoline and kerosene mists, engine 10 must be fitted with liquid fuel spray nozzles positioned in front of the enlarged intake mouths 17 and 22. The requirements or specifications for operating engine 10 on volatile hydrocarbons as vapors or liquid mists are identical to those described in my U.S. Pat. No. 6,216,446.

Engines of this invention are not limited to three intake tubes per intake duct, but may have as many as five intake tubes in the intake duct. As a practical matter, the modifications described herein so dramatically increase air capture that adding more intake stages (tubes), to provide additional air-aspirating stages is not necessary. Some benefits may be derived from using intake ducts of more than three intake tubes when constructing very large engines. An intake duct of up to five intake tubes is,therefore, within the scope of this invention, and operation would be the same regardless of how many intake tubes are employed.

It has been found that further increases or boosts in static thrust may result from the injection of a gaseous oxidizer such as nitrous oxide into intake tube 7 or intake tube 8. Such injection simulates the effect of ram air entering the intake duct during dynamic operation. This boost in static thrust with the injection of oxidizers is to be expected;such oxidizers have the same effecton combustion engines of many types.

The modifications I have described above result in improved static thrust, improved dynamic trust,and fuel efficiency. They are the result of extensive, continued research into pulse-jet operation; They are novel and represent a significant advancement in valveless pulse-jet engine technology.

While in the forgoing specification, an embodiment of the invention has been set forth in considerable detail for the purposes of making a complete disclosure thereof, it will be apparent to those skilled in the art that numerous changes may be made in such detail without departing from the spirit and principles of the invention.

References Cited
UNITED STATES PATENTS

| | | | |
|---|---|---|---|
| 2,663,142 | December 1953 | Wilson | 60/39.71 |
| 3,035,413 | May 1962 | Linderoth | 60/39.77 |
| 3,093,962 | June 1963 | Gluhareff | 60/35.6 |
| 3,514,956 | June 1970 | Bray | 60/269 |
| 3,768,257 | October 1973 | Neuffer | 60/269 |

What is claimed is:

1. A self starting, self aspirating, valveless jet engine, comprising:
(a) a combustor tube consisting of a combustion chamber closed at its forward end by a flat or convex face, said combustion chamber communicating with an exhaust tail tube by way of an intermediate reducing cone, said combustor tube having a length of 4-9 times the diameter of the combustion chamber, said exhaust tail tube open to the atmosphere at its aft end and having a diameter of 0.66-0.90 times the diameter of the combustion chamber, with the combustion chamber, reducing cone, and exhaust tail tube all arranged on a common longitudinal axis,
(b) an intake duct to capture air, and mix it into vaporized fuel, and feed the fuel-air mixture to the combustion chamber, said intake duct penetrating the forward face of the combustion chamber at its center, said intake duct positioned on a common longitudinal axis with the combustor tube, and comprising three to five intake tubes of varying diameters, wherein each intake tube has an enlarged inlet mouth, finished with a flare, at its forward end that is 40-100% larger in diameter than its aft end diameter, and a diameter at its aft end that is 35-55% of the diameter of the aft end diameter of the intake tube just behind and to the aft of it, except for the intake tube inserted into the primary intake tube, which has a diameter of 80-95% of the primary intake tube, said intake tubes arranged in order of increasing diameter with the smaller diameter tubes at the forward end of the intake duct, and each intake tube partially inserted into the forward end of the intake tube behind and to the aft of it, with the last intake tube in the sequence being the primary intake tube, having a length approximately equal to the diameter of the combustion chamber, and a diameter that is 40-50% ofthe diameter ofthe combustion chamber, said primary intake tube penetrating the forward face of the combustion chamber at its center and integrally joined to the forward face of the combustion chamber around the circumference of said primary intake tube, said primary intake tube extending into the combustion chamber to a length approximately equal to 50% of its length, with the adjacent intake tube just forward of the primary intake tube having a length of 1.25-2.0 times the length of the primary intake tube, and inserted into the primary intake tube at a position which is 0.0-1.0 times its diameter from the vertical plane created by the forward wall of the combustion chamber, each remaining intake tube in the intake duct having a length of 0.50-1.00 times the intake tube behind, and to the aft of it, and all the intake tubes in the intake duct arranged with their centers aligned, p1 (c) a flame holder, comprising a coiled wire or suitable solid surface of minimum cross section, position inside the combustion chamber, adjacent to the aft end of the primary intake tube, so said flame older comes in contact with the fuel-air mixture as it enters the combustion chamber to ignite it,
(d) a fuel supply means comprising a fuel tank capable of retaining liquified gaseous hydrocarbon fuel, a suitable means to fill the tank and draw liquid from the tank, a fuel supply or tank valve leading to a fuel line of lesser diameter than a vaporizer tube and vaporizer coils downstream, said fuel line feeding to a throttle valve to vary the liquid fuel feed rate to the vaporizer tube, said vaporizer tube penetrating the wall of the combustion chamber and extending inside the combustion chamber where said vaporizer tube is coiled to form a series of vaporizer coils which super heat the liquid fuel, transforming it into a vapor which flows through a straight section of the vaporizer tube, said straight section of the fuel line extending out the combustion chamber to the atmosphere, through a small in the combustion chamber, where it is fitted at its end with a supersonic fuel nozzle which is positioned directly in front and at the center of the enlarged mouth of the first forward intake tube of the intake duct and,
(e) a spark plug for igniting the fuel-air mixture, said spark plug located anywhere on the combustor tube, and activated by a suitable electrical source.

2. The jet engine according to claim 1, wherein the reducing cone is extended so as to replace the exhaust tail tube, said reducing cone having the same aft end diameter of the exhaust tail tube it replaces, and a length equal to the length of the reducing cone plus the exhaust tail tube where the exhaust tail tube is part of the structure.

3. The engine according to claim 1, wherein a second fuel supply means is included to feed a vaporized liquid hydrocarbon as a second fuel to the intake duct, said fuel supply means consisting of a means to supply the liquid fuel under pressure so as to drive the fuel through a fuel line of lesser diameter than the vaporizer tube and a series of vaporizer coils downstream, said fuel line feeding to a throttle valve to vary the liquid fuel feed rate to the vaporizer tube, said vaporizer tube penetrating the wall of the combustion chamber where it forms a series of vaporizer coils which superheat the liquid fuel transforming it into a vapor which flows through a straight section of the vaporizer tube, said straight section extending out the combustion chamber through a small hole in the combustion chamber, where it is fitted at its end with a supersonic fuel nozzle positioned directly in front and near the center of the enlarged mouth of the first forward intake tube of the intake duct.

4. The engine according to claim 2, wherein a second fuel supply means is included to feed a vaporized liquid hydrocarbon as a second fuel to the intake duct, said fuel supply means consisting of a means to supply the liquid fuel under pressure so as to drive the fuel through a fuel line of lesser diameter than the vaporizer tube and a series of vaporizer coils downstream, said fuel line feeding to a throttle valve to vary the liquid fuel feed rate to the vaporizer tube, said vaporizer tube penetrating the wall of the combustion chamber where it forms a series of vaporizer coils which superheat the liquid fuel transforming it into a vapor which flows through a straight section of the vaporizer tube, said straight section extending out the combustion chamber through a small hole in the combustion chamber, where it is fitted at its end with a super sonic fuel nozzle positioned directly in front and near the center of the enlarged mouth of the first forward intake tube of the intake duct.

5. The engine according to claim 1, wherein the engine has an additional fuel supply means to feed a volatile liquid hydrocarbon mist into the intake duct, said fuel supply means consisting of one or more liquid fuel spray nozzles positioned at any of the inlet mouths of the intake tubes of the intake duct, except at the mouth of the primary intake tube, said fuel spray nozzles being fed from a supply of volatile liquid hydrocarbon fuel under pressure, including a throttle valve to vary the fuel feed rate, and a suitable means to equally distribute the liquid fuel to the fuel spray nozzles.

6. The engine according to claim 2, wherein the engine has an additional fuel supply means to feed a volatile liquid hydrocarbon mist into the intake duct, said fuel supply means consisting of one or more liquid fuel spray nozzles positioned at any of the inlet mouths of the intake tubes of the intake duct, except at the mouth of the primary intake tube, said fuel spray nozzles being fed from a supply of volatile liquid hydrocarbon fuel under pressure, including a throttle valve to vary the fuel feed rate, and a suitable means to equally distribute the liquid fuel to the fuel spray nozzles.
